(19) United States
(12) Patent Application Publication
(10) Pub. No.: US 2016/0223071 A1
(43) Pub. Date: Aug. 4, 2016

(54) TRANSMISSION SYSTEM FOR MACHINE

(71) Applicant: Caterpillar Inc., Peoria, IL (US)

(72) Inventors: Kevin G. Meyer, Germantown Hills, IL (US); James S. Rice, Deer Creek, IL (US)

(73) Assignee: Caterpillar Inc., Peoria, IL (US)

(21) Appl. No.: 15/095,090

(22) Filed: Apr. 10, 2016

(51) Int. Cl. F16H 57/04

(52) U.S. Cl. CPC F16H 57/0473; F16H 57/0484

(57) ABSTRACT

A transmission system of a machine is provided. The transmission system includes a housing member having an outer surface and an inner surface. The transmission system includes a clutch assembly disposed within the housing member. The transmission system also includes a clutch cooling system associated with the housing member to selectively supply a fluid to the clutch assembly. The clutch cooling system includes a reservoir for storing the fluid and a pump in fluid communication with the reservoir. The clutch cooling system further includes a fluid supply unit configured to supply the fluid from the reservoir to the clutch assembly. The clutch cooling system supplies the fluid at a plurality of locations around a circumference of the clutch assembly.

### TECHNICAL FIELD

The present disclosure relates to transmission systems, and more specifically relates to a cooling system for a transmission system of a machine.

### BACKGROUND

Stationary clutches are frequently employed in various machines to hold rotating components, such as a sun gear, a ring gear, or a planet carrier of a transmission system. The stationary clutches control torque or speed ratios received from the rotating components During operation of the stationary clutches, i.e., engagement and disengagement of the stationary clutches, heat is generated due to friction between contact surfaces.

Conventionally, in order to remove the heat generated, cooling oil is supplied to a contact surface of the stationary clutch through a number of holes. The holes are typically formed in a clutch hub. However, when the stationary clutch is engaged, i.e., when the clutch hub is stationary, cooling oil usually does not reach the contact surface. When the stationary clutch is disengaged, i.e., when the clutch hub rotates, then the cooling oil is again supplied through the holes to the contact surface. However, due to flow of the cooling oil through the holes in the clutch hub, a viscous drag is generated leading to parasitic losses in the transmission system.

U.S. Pat. No. 5,810,142, hereinafter referred to as '142 patent, discloses a valve for flow control. The valve is provided with a flow recess and with a valve seat inside the flow recess. The valve seat is located beyond the axis of rotation of a rotating component and extends parallel to the axis of rotation. Inside the flow recess there is a movable valve body which interacts with the valve seat. A return spring takes effect on the valve body and the valve body is pressed in a closed position in the valve seat by the flow medium. However, the '142 patent discloses use of the valve for controlling the flow of lubricant in the clutch housing. Further '142 patent discloses use of pressurized fluid to actuate the valves.

### SUMMARY OF THE DISCLOSURE

In one aspect of the present disclosure, a transmission system of a machine is provided. The transmission system includes a housing member having an outer surface and an inner surface. The transmission system includes a clutch assembly disposed within the housing member. The clutch assembly includes at least one separator plate and at least one friction disc. The at least one separator plate is coupled with the inner surface of the housing member. The at least one friction disc is adapted to be engaged and disengaged with the at least one separator plate. The at least one friction disc is coupled with an engaging member of a gear set of the transmission system. The transmission system also includes a clutch cooling system. The clutch cooling system is associated with the housing member to selectively supply a fluid to the clutch assembly. The clutch cooling system includes a reservoir for storing the fluid. The clutch cooling system also includes a pump in fluid communication with the reservoir. Further, the clutch cooling system includes a fluid supply unit in fluid communication with the pump. The fluid supply unit is configured to supply the fluid from the reservoir to the clutch assembly. The clutch cooling system supplies the fluid at a plurality of locations around a circumference of the clutch assembly.

Other features and aspects of this disclosure will be apparent from the following description and the accompanying drawings.

### BRIEF DESCRIPTION OF THE DRAWING

FIG. 1 is a schematic side view of a machine having a transmission system with a clutch cooling system, according to one embodiment of the present disclosure:

FIG. 2 is a schematic view of the transmission system of FIG. 1, illustrating the clutch cooling system;

FIG. 3 is a sectional view of the transmission system with the clutch cooling system, taken along a line A-A′ of FIG. 2;

FIG. 4 is a sectional view of the transmission system with a clutch cooling system, taken along a line A-A′ of FIG. 2, according to another embodiment of the present disclosure; and

FIG. 5 is a sectional view of the transmission system with a clutch cooling system, taken along a line A-A′ of FIG. 2, according to yet another embodiment of the present disclosure.

### DETAILED DESCRIPTION

Reference will now be made in detail to specific embodiments or features, examples of which are illustrated in the accompanying drawings. Wherever possible, corresponding or similar reference numbers will be used throughout the drawings to refer to the same or corresponding parts.

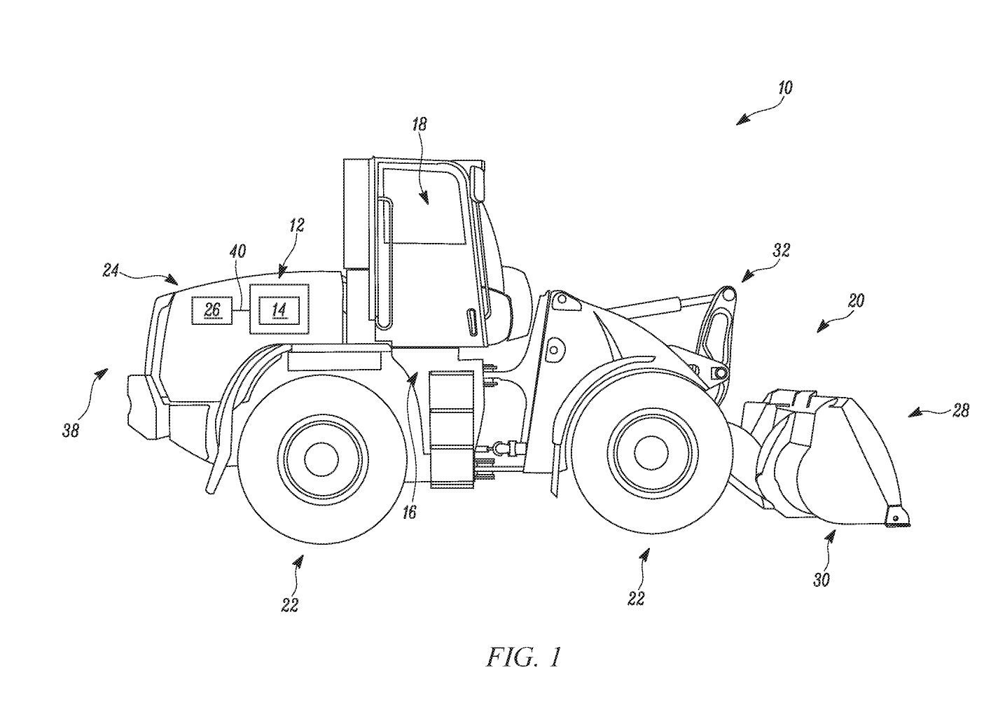

FIG. 1 is a schematic view of a machine 10 having a transmission system 12 having a clutch cooling system 14, according to one embodiment of the present disclosure. The machine 10 may be an earth moving machine that may include, but is not limited to, a backhoe, an excavator, a tractor, a loader, a motor grader, or any other earth moving machine. In the present example, the machine 10 is embodied as a wheel loader.

The machine 10 includes a frame 16, an operator cabin 18 for accommodating an operator, an implement system 20 coupled to the frame 16, a pair of ground engaging members 22 for propelling the machine 10, a compartment 24 for accommodating a power source 26, the transmission system 12 drivably coupled to the power source 26, and the clutch cooling system 14.

The operator cabin 18 is supported on the frame 16 of the machine 10. The operator cabin 18 includes a number of input devices (not shown) for controlling of the machine 10. The input devices (not shown) may include, but are not limited to, a push-button, a control lever, and a steering wheel. The input devices are provided to control a movement of the implement system 20 to different positions, in order to perform various operations such as, a loading operation, a dumping operation, an excavating operation, or any other earthmoving operation known in the art.

The implement system 20 is disposed at a front end 28 of the machine 10. The implement system 20 includes a bucket 30 pivotally coupled to a linkage member 32. The linkage member 32 is connected to the frame 16 of the machine 10. In other examples, the implement system 20 may include, but is not limited to, an auger, a blade, a fork, a hammer, and a ripper.

The power source 26 is accommodated in the compartment 24 at a rear end 38 of the machine 10, The power source 26 includes an internal combustion engine. The internal combustion engine may be a diesel engine, a gasoline engine, a gaseous fuel-powered engine, a turbine engine, or any other type of combustion engine known in the art. In other examples, the power source 26 may be anon-combustion source of power, such as a fuel cell or a battery. The power source 26 is provided for generating power to propel the machine 10 and to operate the implement system 20 of the machine 10. The power source 26 is connected to the transmission system 12. More specifically, the power source 26 is connected to the transmission system 12 through an input member 40. In one example, the power source 26 may be connected to a torque convertor (not shown) that is further connected to the transmission system 12 through the input member 40.

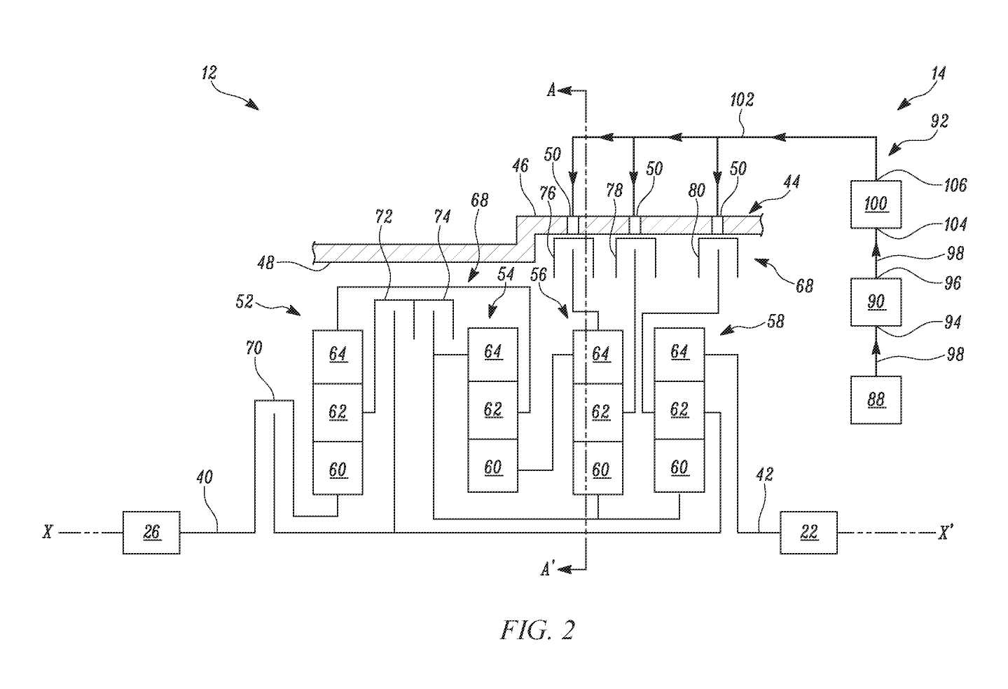

FIG. 2 illustrates a schematic view of the transmission system 12 with the clutch cooling system 14. Referring to FIG. 1 and FIG. 2, the transmission system 12 is connected to the pair of ground engaging members 22. More specifically, the transmission system 12 is connected to the pair of ground engaging members 22 through an output member 42. The transmission system 12 supplies power received from the power source 26 to the pair of ground engaging members 22 through the output member 42.

The transmission system 12 is embodied as a multi-speed transmission system. The transmission system 12 includes a housing member 44 having an outer surface 46 and an inner surface 48. The housing member 44 is rigidly attached to the frame 16 of the machine 10. The housing member 44 includes a plurality of holes 50 extending from the outer surface 46 to the inner surface 48. As illustrated, the holes 50 are circumferentially distributed in the housing member 44. The holes 50 are in fluid communication with the clutch cooling system 14.

The transmission system 12 includes a number of gear sets 52, 54, 56, 58. Each of the gear sets 52, 54, 56, 58 is rotatably supported within the housing member 44. The gear sets 52, 54, 56, 58 are aligned about a rotational axis X-X′ of the output member 42. Each of the gear sets 52, 54, 56, 58 is drivably coupled to each other, for transmitting the output power from the power source 26 to the pair of ground engaging members 22 through the output member 42. Further, the gear sets 52, 54, 56, 58 are drivably coupled to the input member 40 and the output member 42. The gear sets 52, 54, 56, 58 are provided to control a power output received by the pair of ground engaging members 22 at the output member 42 from the power source 26.

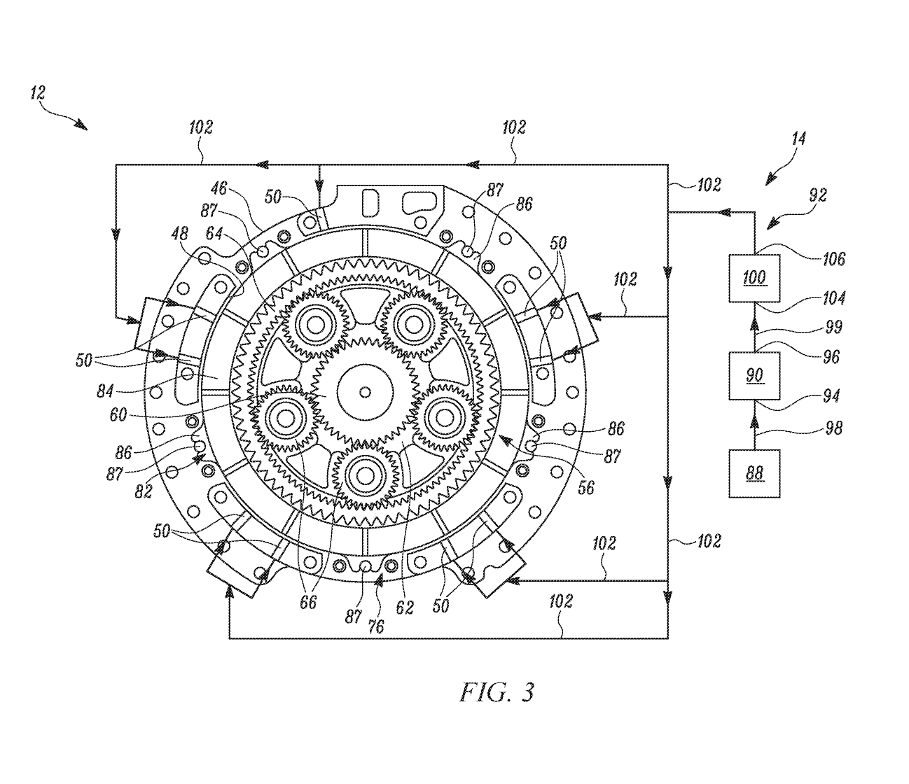

Each of the gear sets 52, 54, 56, 58 includes a number of engaging members. The number of engaging members includes a sun gear 60, a planetary carrier 62, and a ring gear 64. The sun gear 60 rotates about the rotational axis X-X′ of the output member 42. The planetary carrier 62 is provided to support a number of planet gears 66 (shown in FIG. 3). The planet gears 66 are circumferential spaced about the sun gear 60. The planet gears 66 mesh with the sun gear 60 and the ring gear 64. In one example, the sun gear 60, the planetary carrier 62, the ring gear 64, and the planet gears 66 may be rotated as a single unit. In another example, alternatively, the planetary carrier 62, and the ring gear 64 may be held stationary.

Further, the transmission system 1 includes a number of control elements 68 disposed within the housing member 44. The control elements 68 are operatively coupled to the gear sets 52, 54, 56, 58. The control elements 68 are provided to control the power output received by the pair of ground engaging members 22 at the output member 42. More specifically, the control elements 68 are selectively engaged with the gear sets 52, 54, 56, 58 to obtain, for example, a set of ten forward gear ratios and one reverse gear ratio between the input member 40 and the output member 42. In one example, the control elements 68 may also include, but are not limited to, synchronizers, brakes, or a combination thereof.

The control elements 68 are hydraulically operated to control the power output at the output member 42. In one example, the control elements 68 may be electronically operated to control the power output at the output member 42. The control elements 68 include a number of rotational clutches 70, 72, 74 and a number of clutch assemblies 76, 78, 80. The rotational clutches 70, 72, 74 are disposed within the housing member 44 of the transmission system 12.

FIG. 3 is a sectional view of the transmission system 12 with the clutch cooling system 14, taken along a line A-A′ of FIG. 2. Referring to FIG. 2 and FIG. 3, each of the clutch assemblies 76, 78, 80 is provided to selectively hold the sun gear 60, the planetary carrier 62, and the ring gear 64 stationary, thereby controlling the power output at the output member 42. More specifically, the clutch assemblies 76, 78, 80 control a rotational speed of the output member 42 with respect to the input member 40 by obtaining different gear ratios between the gear sets 52, 54, 56, 58. Each of the clutch assemblies 76, 78, 80 includes a number of separator plates 82 and a number of friction discs 84. It should be noted that although the present disclosure is described with regard to the clutch assembly 76, the description is applicable to the clutch assemblies 78, 80 as well, without departing from the scope of the present disclosure.

The separator plates 82 of the clutch assembly 76 are coupled with the inner surface 48 of the housing member 44. Each of the separator plates 82 includes a number of engaging portions 86 disposed circumferentially on the separator plates 82. The engaging portions 86 are coupled to the inner surface 48 of the housing member 44. More specifically, the engaging portions 86 are coupled to a number of rods 87 that are connected to the inner surface 48 of the housing member 44. In one example, the engaging portions 86 are coupled to spline teeth (not shown) formed on the inner surface 48 of the housing member 44.

The friction discs 84 are adapted to be engaged with the separator plates 82. Each of the friction discs 84 and the separator plates 82 are alternatively stacked on each other in the housing member 44 to form a clutch pack. More specifically, the friction discs 84 and the separator plates 82 are interleaved. The friction discs 84 are coupled with one of the engaging members of the gear set 56 of the transmission system 12. More specifically, each of the friction discs 84 is coupled with the ring gear 64 of the gear set 56. The friction discs 84 are adapted to rotate along with the ring gear 64 of the gear set 56, when the clutch assembly 76 is in a disengaged condition. In the disengaged condition, the friction discs 84 disengages with the separator plates 82 of the clutch assembly 76. When the clutch assembly 76 is in an engaged condition, the friction discs 84 engages with the separator plates 82, thereby locking the friction discs 84 to the housing member 44 along with the ring gear 64.

During the engaged condition of the clutch assembly 76, the separator plates 82 engage with the friction discs 84 to hold the ring gear 64 stationary with respect to the housing member 44 of the transmission system 12. In one example, the clutch assembly 76 may include an actuating mechanism, (not shown) such as a piston assembly for engaging the friction discs 84 with the separator plates 82. Due to engagement of the friction discs 84 with the separator plates 82, friction energy is generated between contact surfaces (not shown) of the separator plates 82 and the friction discs 84. The term “contact surfaces” herein refers to surfaces of the separator plates 82 and the friction discs 84 which come in contact with each other during the engaged condition of the clutch assembly 76. During the disengaged condition of the clutch assembly 76, the friction discs 84 rotate freely along with the ring gear 64 of the gear set 56.

The clutch cooling system 14 is provided in the transmission system 12 to supply a fluid to the contact surfaces of the separator plates 82 and the friction discs 84. The clutch cooling system 14 is associated with the housing member 44 to selectively supply the fluid to the clutch assembly 76. Specifically, the clutch cooling system 14 is associated with the housing member 44 to selectively supply the fluid to the clutch assembly 76 through the holes 50 of the housing member 44. The clutch cooling system 14 supplies the fluid at a plurality of locations around a circumference of the clutch assembly 76 through the plurality of holes 50. More specifically, the clutch cooling system 14 supplies the fluid at the plurality of locations around the circumference of the clutch assembly 76, while the friction discs 84 is engaged with the separator plates 82 of the clutch assembly 76. In an example, the clutch cooling system 14 supplies the fluid at the plurality of locations around the circumference of the clutch assembly 76, while the friction discs 84 is disengaged with the separator plates 82 of the clutch assembly 76. As shown in FIGS. 2 and 3, the clutch cooling system 14 includes a reservoir 88, a pump 90, and a fluid supply unit 92. In one example, the reservoir 88 may be a tank for storing the fluid at a predefined pressure. In another example, the reservoir 88 may be an oil pan (not shown) provided within the transmission system 12 of the machine 10. The fluid may include, but is not limited to, engine cooling oil, transmission cooling oil, or any other fluid known in the art.

The pump 90 is in fluid communication with the reservoir 88. The pump 90 draws the fluid from the reservoir 88 to the housing member 44 of the transmission system 12. More specifically, the pump 90 draws the fluid from the reservoir 88 to the holes 50 formed on the housing member 44 of the transmission system 12. The pump 90 includes an inlet 94 and an outlet 96. The inlet 94 is connected to the reservoir 88 through a fluid duct 98 for receiving the fluid from the reservoir 88. The outlet 96 is connected to the fluid supply unit 92 for supplying the fluid to the fluid supply unit 92. The pump 90 is drivably connected to the power source 26 of the machine 10.

The fluid supply unit 92 is in fluid communication with the pump 90 and the holes 50 of the housing member 44 of the transmission system 12. The fluid supply unit 92 receives the fluid from the reservoir 88 through the pump 90. The fluid supply unit 92 supplies the fluid from the reservoir 88 to the clutch assembly 76. More specifically, the fluid supply unit 92 supplies the fluid to the clutch assembly 76 through the holes 50 of the housing member 44. The fluid supply unit 92 controls a flow of the fluid from the reservoir 88 to the clutch assembly 76 through the holes 50 of the transmission system 12.

The fluid supply unit 92 includes a flow control unit 100 and a number of fluid conduits 102. The flow control unit 100 includes an inlet port 104 and an outlet port 106. The inlet port 104 is connected to the outlet 96 of the pump 90 through a fluid duct 99 for receiving the fluid from the pump 90. The outlet port 106 is connected to the holes 50 of the housing member 44 through the fluid conduits 102 for supplying the fluid to the holes 50. More specifically, the outlet port 106 is connected to each of the holes 50 of the housing member 44 through the fluid conduits 102. Further, the holes 50 of the housing member 44 dispense the fluid received from the outlet port 106 on each of the separator plates 82 and the friction discs 84 of the clutch assembly 76. The flow control unit 100 may include, but is not limited to, a solenoid valve, a pilot actuated valve, and a spool valve.

In one example, the flow control unit 100 may be the solenoid valve actuated by an electric current supplied to the solenoid valve. In another example, the flow control unit 100 may be the pilot actuated valve operated by a clutch pressure. In the present example, the pilot actuated valve is operated to an open position and a closed positon, based on the clutch pressure detected during the engaged condition of the clutch assembly 76. In yet another example, the flow control unit 100 may be embodied as the spool valve mechanically operated by the actuating mechanism, such as the piston. In the present example, the spool valve is switched to an open position and a closed position, based on the movement of the piston during the engaged condition of the clutch assembly 76. In one example, the flow control unit 100 may supply the fluid to the holes 50 of the housing member 44 in the engaged condition and the disengaged condition of the clutch assembly 76. In one example, the clutch cooling system 114 supplies the fluid continuously from the reservoir 88 to the clutch assembly 76 through the holes 50 of the housing member 44, in the engaged condition and the disengaged condition of the clutch assembly 76. In the present example, the flow control unit 100 is redundant in the fluid supply unit 92 of the clutch cooling system 114.

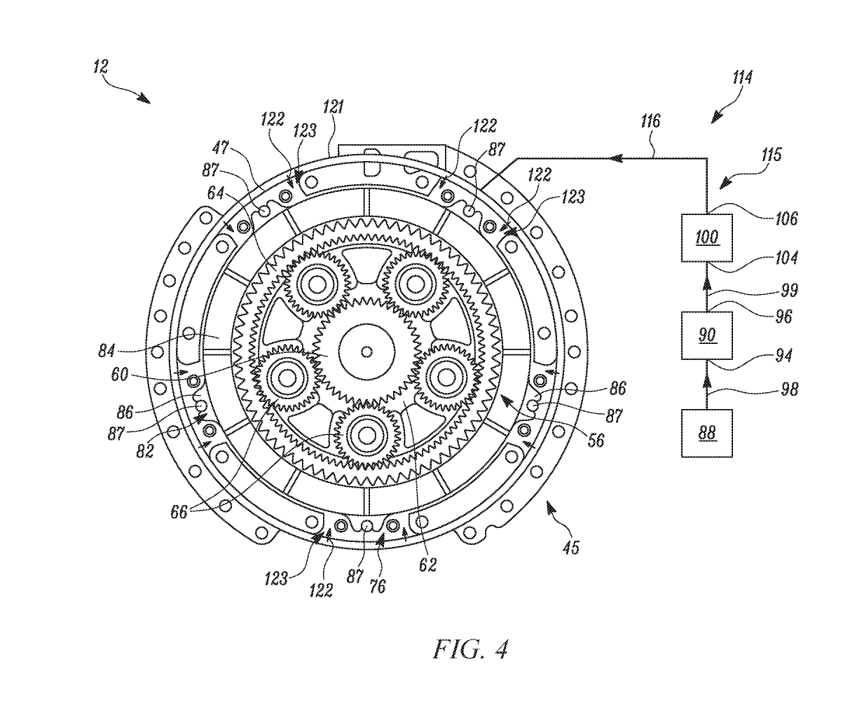

FIG. 4 is a sectional view of the transmission system 12 with a clutch cooling system 114, taken along a line A-A′ of FIG. 2, according to another embodiment of the present disclosure. Similar to the clutch cooling system 14 of the transmission system 12 in FIG. 3, the clutch cooling system 114 of FIG. 4 includes a reservoir, such as the reservoir 88, a pump, such as the pump 90, and a fluid supply unit 115.

The fluid supply unit 115 includes a fluid conduit 116 and a flow control unit, such as the flow control unit 100. The fluid supply unit 115 is in fluid communication with the pump 90 and a housing member 45 of the transmission system 12. The flow control unit 100 includes an inlet port, such as the inlet port 104 and an outlet port, such as the outlet port 106. As explained earlier, the inlet port 104 is connected to the outlet 96 of the pump 90.

The fluid supply unit 115 also includes a cylindrical tube 121. The cylindrical tube 121 is positioned on an outer surface 47 of the housing member 45. The cylindrical tube 121 is connected to the outlet port 106 of the flow control unit 100 through the fluid conduit 116. The cylindrical tube 121 is in fluid communication with the flow control unit 100 through the fluid conduit 116 for receiving the fluid from the reservoir 88. The cylindrical tube 121 includes a number of orifices 122 circumferentially spaced apart on the cylindrical tube 121. The orifices 122 spray the fluid on the clutch assembly 76 through a number of openings 123 circumferentially distributed in the housing member 45. More specifically, the orifices 122 dispense the fluid received from the reservoir 88 on each of the separator plates 82 and the friction discs 84 of the clutch assembly 76 through the openings 123 of the housing member 45.

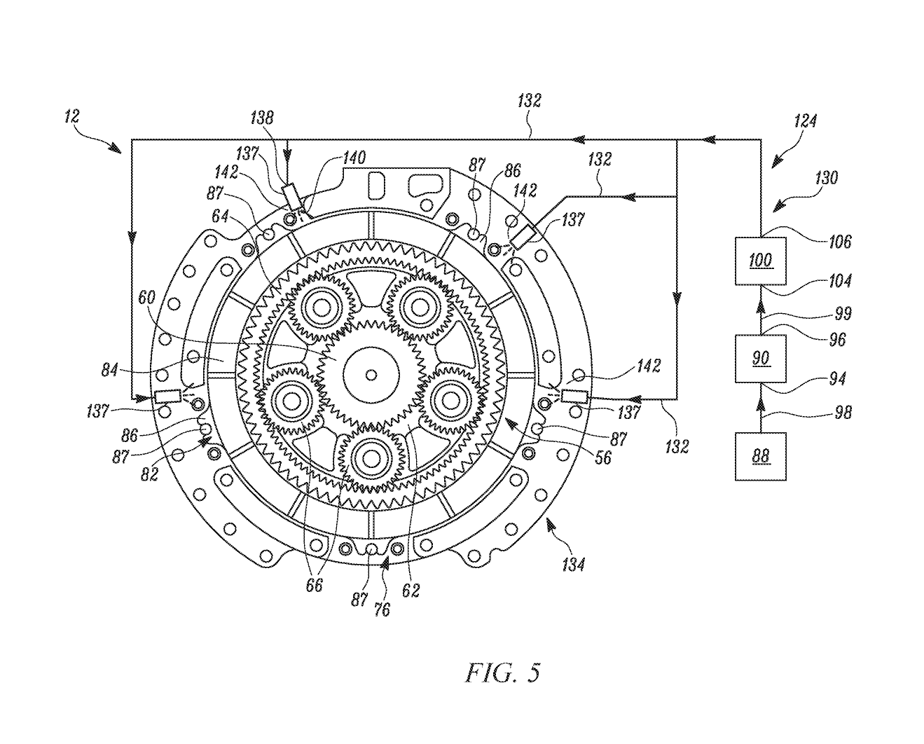

FIG. 5 is a sectional view of the transmission system 12 with a clutch cooling system 124, taken along a line A-A′ of FIG. 2, according to yet another embodiment of the present disclosure. Similar to the clutch cooling system 14 of the transmission system 12 in FIG. 3, the clutch cooling system 124 of FIG. 5 includes a reservoir, such as the reservoir 88, a pump, such as the pump 90, and a fluid supply unit 130. The pump 90 includes an inlet, such as the inlet 94 and an outlet, such as the outlet 96. As explained earlier, the inlet 94 is connected to the reservoir 88 and the outlet 96 is connected to the fluid supply unit 130.

The fluid supply unit 130 includes a number of fluid conduits 132 and a flow control unit, such as the flow control unit 100. The fluid supply unit 130 is in fluid communication with the pump 90 and a housing member 134. The flow control unit 100 includes an inlet port, such as the inlet port 104 and an outlet port, such as the outlet port 106. The inlet port 104 is connected to the outlet 96 of the pump 90.

The fluid supply unit 130 also includes a number of spraying units 137. The spraying units 137 are positioned in a number of openings 142 circumferentially distributed in the housing member 134. Each of the spraying units 137 includes an inlet 138 and an outlet 140. The inlet 138 is connected to the flow control unit 100 through the fluid conduits 132 for receiving the fluid from the reservoir 88. More specifically, the inlet 138 is connected to the outlet port 106 of the flow control unit 100 through the fluid conduits 132. The outlet 140 dispenses the fluid received from the reservoir 88 on each of the separator plates 82 and the friction discs 84 of the clutch assembly 76.

### INDUSTRIAL APPLICABILITY

The present disclosure relates to the clutch cooling systems 14, 114, 124 for the transmission system 12 of the machine 10. The clutch cooling systems 14, 114, 124 selectively supply the fluid to the clutch assembly 76 for cooling of the clutch assembly 76. The holes 50 formed on the housing member 44 enable supply of the fluid to the clutch assembly 76. A number of holes 50 can be varied to achieve a desired amount of flow of fluid for cooling of the clutch assembly 76. The clutch cooling system 14 includes the fluid supply unit 92 that supplies the fluid to the clutch assembly 76 during the engaged condition and the disengaged condition of the clutch assembly 76. Therefore, the clutch cooling system 14 can reduce temperature of the clutch assembly 76 when the clutch assembly 76 is in the engaged condition as well as when the clutch assembly 76 is in the disengaged condition.

The fluid supply unit 92 supplies the fluid from the reservoir 88 to the clutch assembly 76 in the transmission system 12 through the holes 50. The holes 50 supply the fluid to the clutch assembly 76 and are provided on the housing member 44. Therefore, the fluid supplied to the clutch assembly 76 flows from the outer surface 46 of the housing member 44 to the inner surface 48 of the housing member 44. As a result, drag losses arising from fluid flowing through a clutch hub are reduced. Accordingly, parasitic losses in the transmission system 12 are also reduced. by the clutch cooling systems 14, 114, 124 of the present disclosure. Further, the spraying units 137 of the clutch cooling system 124 can be used for cooling the clutch assembly 76, when the clutch assembly 76 is located within the housing member 134 at a larger distance from the inner surface 48 of the housing member 134.

The clutch cooling system 14 of the present disclosure facilitates supply of the fluid, through the holes 50 on the housing member 44, directly to the clutch assembly 76. Therefore, the clutch cooling system 14 increases a cooling rate of the clutch assembly 76 when the clutch is engaged. The clutch cooling system 14 can be employed along with another conventional cooling system to further increase the cooling rate of the clutch assembly 76. Further, the clutch cooling system 14 can be conveniently retrofittable with a variety of other transmission systems.

The clutch cooling system 14 can be used in various types of transmission systems, such as a semi-automatic transmission and an automatic transmission. Further, the clutch cooling system 14 can be employed in the transmission system 12 of any type of machine used in construction applications, transportation applications, power generation applications, aerospace applications, locomotive applications, marine applications, and other engine power applications. Therefore, the clutch cooling system 14 has a wide range of application across industries. Therefore, the present disclosure offers the transmission system 12 with the clutch cooling system 14 that is economical and cost effective.

While aspects of the present disclosure have been particularly shown and described with reference to the embodiments above, it will be understood by those skilled in the art that various additional embodiments may be contemplated by the modification of the disclosed machines, systems, and methods without departing from the spirit and scope of what is disclosed. Such embodiments should be understood to fall within the scope of the present disclosure as determined based upon the claims and any equivalents thereof.

What is claimed is:

1. A transmission system of a machine, the transmission system comprising:
a housing member having an outer surface and an inner surface;
a clutch assembly disposed within the housing member, the clutch assembly including:
at least one separator plate coupled with the inner surface of the housing member; and
at least one friction disc adapted to be engaged and disengaged with the at least one separator plate, wherein the at least one friction disc is coupled with an engaging member of a gear set of the transmission system;
and
a clutch cooling system associated with the housing member to selectively supply a fluid to the clutch assembly, the clutch cooling system including:
a reservoir for storing the fluid;
a pump in fluid communication with the reservoir; and
a fluid supply unit in fluid communication with the pump, he fluid supply unit being configured to supply the fluid from the reservoir to the clutch assembly,
wherein the clutch cooling system supplies the fluid at a plurality of locations around a circumference of the clutch assembly.
